(19) United States
(12) Patent Application Publication
(10) Pub. No.: US 2018/0146455 A1
(43) Pub. Date: May 24, 2018

(54) USER TERMINAL, RADIO BASE STATION, RADIO COMMUNICATION SYSTEM AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Jing Wang, Beijing (CN); Liu Liu, Beijing (CN); Huiling Jiang, Beijing (CN)

(73) Assignee: NTT DOCOMO, INC., Tokyo (JP)

(21) Appl. No.: 15/563,690

(22) PCT Filed: Apr. 8, 2016
(86) PCT No.: PCT/JP2016/061503

§ 371 Date: Oct. 2, 2017

(30) Foreign Application Priority Data
Apr. 9, 2015 (JP) 2015-080328

(51) Int. Cl. H04W 72/04; H04L 5/00; H04W 72/12

(52) U.S. Cl. CPC H04W 72/042; H04L 5/0055; H04W 16/14; H04W 72/1289; H04W 72/0453; H04W 72/1273

(57) ABSTRACT

The present invention is designed so that it is possible to increase the EPDCCH capacity for transmitting control information that is required in cross-carrier scheduling in enhanced carrier aggregation. A user terminal can communicate with a radio base station using six or more component carriers, and has a control section that exerts control so that, based on one or a plurality of EPDCCH (Enhanced Physical Downlink Control Channel) groups configured by the radio base station, and component carrier indices corresponding to each EPDCCH set group, blind decoding is performed on EPDCCH sets included in the EPDCCH set groups, and DCI (Downlink Control Information) of component carriers corresponding to the EPDCCH set groups is detected.

### TECHNICAL FIELD

The present invention relates to a user terminal, a radio base station, a radio communication system and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). The specifications of LTE-advanced have already been drafted for the purpose of achieving further broadbandization and higher speeds beyond LTE, and, in addition, for example, successor systems of LTE—referred to as, for example, “FRA” (future radio access)—are under study.

Also, the system band of LTE Rel. 10/11 includes at least one component carrier (CC), where the LTE system band constitutes one unit. Such bundling of a plurality of CCs into a wide band is referred to as “carrier aggregation” (CA).

In LTE Rel. 12, which is a more advanced successor system of LTE, various scenarios to use a plurality of cells in different frequency bands (carriers) are under study. When the radio base stations to form a plurality of cells are substantially the same, the above-described carrier aggregation is applicable. On the other hand, when the radio base stations to form a plurality of cells are completely different, dual connectivity (DC) may be employed.

### CITATION LIST

### Non-Patent Literature

Non-Patent Literature 1: 3GPP TS 36. 300 “Evolved Universal Terrestrial Radio Access (E-UTRA) and Evolved Universal Terrestrial Radio Access Network (E-UTRAN); Overall Description; Stage 2”

### SUMMARY OF INVENTION

### Technical Problem

In the carrier aggregation of LTE Rel. 10/11/12, the number of component carriers that can be configured per user terminal is limited to maximum five. In LTE Rel. 13 and later versions, in order to achieve more flexible and faster wireless communication, and the number of component carriers that can be configured per user terminal is made six or greater, and enhanced carrier aggregation to bundle these component carriers is under study.

In existing carrier aggregation, support is provided so that one component carrier can carry out cross-carrier scheduling (CCS) with maximum five component carriers, including the subject component carrier. In enhanced carrier aggregation, there is a need to provided support so that one component carrier can carry out cross-carrier scheduling with six or more component carriers, including the subject component carrier.

In enhanced carrier aggregation, in which the number of component carriers that can be configured per user terminal is in six or more, if cross-carrier scheduling is configured in the same way as in existing carrier aggregation, PDCCHs (Physical Downlink Control Channel) or EPDCCHs (Enhanced PDCCH) might unevenly concentrate in a specific component carrier. Given that the PDCCH or the EPDCCH has limited capacity, cases might occur where DCI (Downlink Control Information) for all component carriers cannot be transmitted or where DCI for a plurality of users cannot be transmitted.

The present invention has been made in view of the above, and it is therefore an object of the present invention to provide a user terminal, a radio base station, a radio communication system and a radio communication method, whereby it is possible to increase the EPDCCH capacity for transmitting control information that is required in cross-carrier scheduling in enhanced carrier aggregation.

### Solution to Problem

According to the present invention, a user terminal can communicate with a radio base station using six or more component carriers, and has a control section that exerts control so that, based on one or a plurality of EPDCCH (Enhanced Physical Downlink Control Channel) set groups configured by the radio base station, and a component carrier index corresponding to each EPDCCH set group, blind decoding is performed on an EPDCCH set included in each EPDCCH set group, and DCI (Downlink Control Information) of a component carriers corresponding to each EPDCCH set group is detected.

### Advantageous Effects of Invention

According to the present invention, it is possible to increase the EPDCCH capacity for transmitting control information that is required in cross-carrier scheduling in enhanced carrier aggregation.

### BRIEF DESCRIPTION OF DRAWINGS

FIG. 1 provide diagrams to explain cross-carrier scheduling in enhanced carrier aggregation;

FIG. 2 is a diagram to explain cross-carrier scheduling in enhanced carrier aggregation;

FIG. 3 provide diagrams to explain conventional EPDCCH sets;

FIG. 4 is a diagram to explain EPDCCH set groups according to the present embodiment;

FIG. 5 is a diagram to explain EPDCCH set groups according to the present embodiment;

FIG. 6 is a diagram to show an example of a schematic structure of a radio communication system according to the present embodiment;

FIG. 7 is a diagram to show an example of an overall structure of a radio base station according to the present embodiment;

FIG. 8 is a diagram to show an example of a functional structure of a radio base station according to the present embodiment;

FIG. 9 is a diagram to show an example of an overall structure of a user terminal according to the present embodiment; and

FIG. 10 is a diagram to show an example of a functional structure of a user terminal according to the present embodiment.

### DESCRIPTION OF EMBODIMENTS

Now, an embodiment of the present invention will be described in detail below with reference to the accompanying drawings. In LTE Rel. 13, enhanced carrier aggregation, in which no limit is placed on the number of component carriers that can be configured per user terminal, is under study. In enhanced carrier aggregation, for example, a study is in progress to bundle maximum 32 component carriers. With enhanced carrier aggregation, more flexible and faster wireless communication can be realized. In addition, by enhanced carrier aggregation, it is possible to bundle a large number of component carrier into an ultra-wide continuous band.

Existing carrier aggregation provides support so that one component carrier can carry out cross-carrier scheduling with maximum five component carriers, including the subject component carrier.

In enhanced carrier aggregation, there is a need to provided support so that one component carrier can carry out cross-carrier scheduling with maximum 32 component carriers, including the subject component carrier. Consequently, one PDCCH (Physical Downlink Control Channel) or EPDCCH (Enhanced PDCCH) need needs to support cross-carrier scheduling using more than five component carriers.

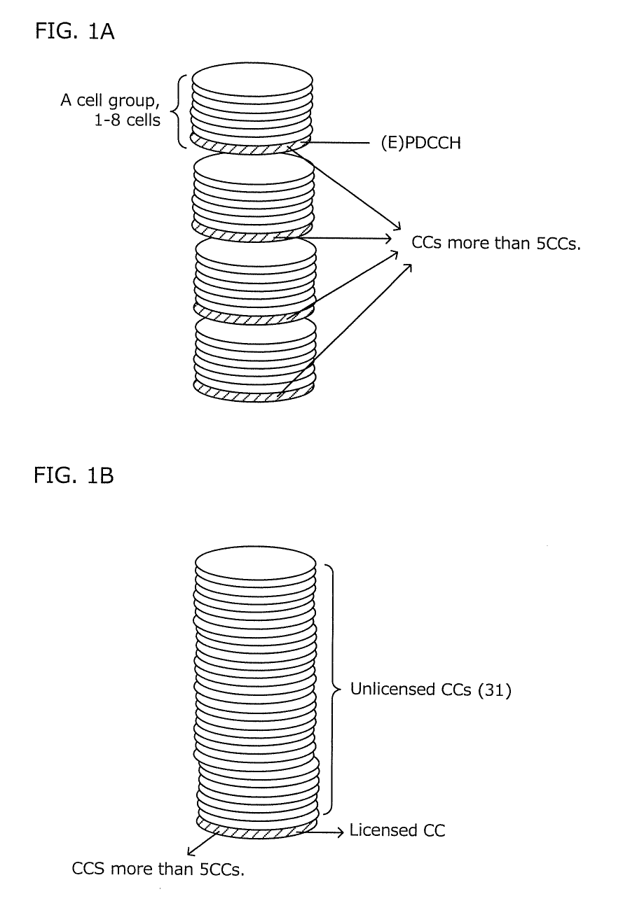

FIG. 1A shows an example, in which maximum 32 component carriers are divided into a plurality of cell groups, each comprised of one to eight component carriers, and cross-carrier scheduling is executed on a per cell group basis. One component carrier conducts cross-carrier scheduling with more than five component carriers (eight component carriers in FIG. 1A). By dividing component carriers into cell groups that are comprised of maximum eight component carriers, the existing 3-bit CIF (Carrier Indicator Field) can be used.

FIG. 1B shows an example in which one component carrier carries out cross-carrier scheduling with maximum 32 component carriers (32 component carriers in FIG. 1B). One component carrier that performs cross-carrier scheduling may be a component carrier in a licensed band, and the other 31 component carriers may be component carriers in unlicensed bands. A license band refers to a frequency band that is licensed to an operator, and an unlicensed band refers to a frequency band that does not require license.

Problems with cross-carrier scheduling in enhanced carrier aggregation include that the PDCCH or the EPDCCH has limited capacity, and that the number of times to try blind decoding of the PDCCH or the EPDCCH and the blocking rate increase.

In conventional cross-carrier scheduling, one PDCCH or EPDCCH supports cross-carrier scheduling of five component carriers. In cross-carrier scheduling in enhanced carrier aggregation, one PDCCH or EPDCCH supports cross-carrier scheduling of six or more component carriers (6 to 32 component carriers).

In cross-carrier scheduling, a user terminal applies blind-decoding to the PDCCH or the EPDCCH and detects DCI (Downlink Control Information), which is a control signal addressed to the subject terminal. The user terminal repeats blind decoding and cyclic redundancy check (CRC) while changing the control channel element (CCE: Control Channel Element) configuring the PDCCH or the control channel element (ECCE: Enhanced CCE) configuring the EPDCCH, and, when DCI addressed to the subject terminal is detected by cyclic redundancy check, performs control based on this DCI.

Since the processing load of the user terminal increases, the entire range of the PDCCH or the EPDCCH is not subjected to the blind decoding, and blind decoding is performed only in search spaces in the PDCCH or the EPDCCH. A common search space and a UE-specific search space are defined as search spaces. The common search space is an area where all user terminals try blind decoding, and scheduling information such as broadcast information is transmitted. The user terminal-specific search space is an area provided per user, and user-specific data scheduling information and the like are transmitted. Cross-carrier scheduling control signals (DCI) can be transmitted only in user terminal-specific search space.

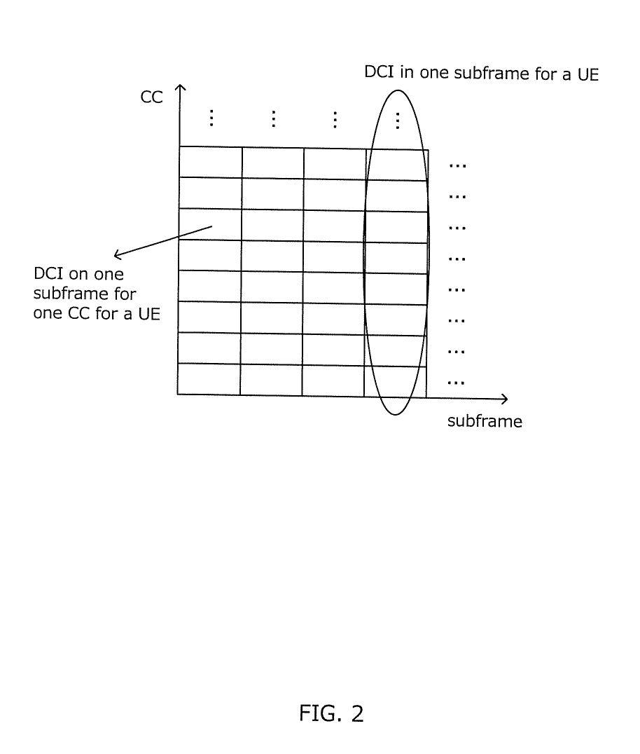

DCI is required depending on the number of component carriers, and, for one component carrier, a DCI is transmitted from one subframe (see FIG. 2). When performing cross-carrier scheduling of 32 component carriers, 64 DCIs are needed in the uplink and the downlink. Therefore, the capacity of the PDCCH or the EPDCCH is limited as the number of component carriers that are supported for cross-carrier scheduling increases.

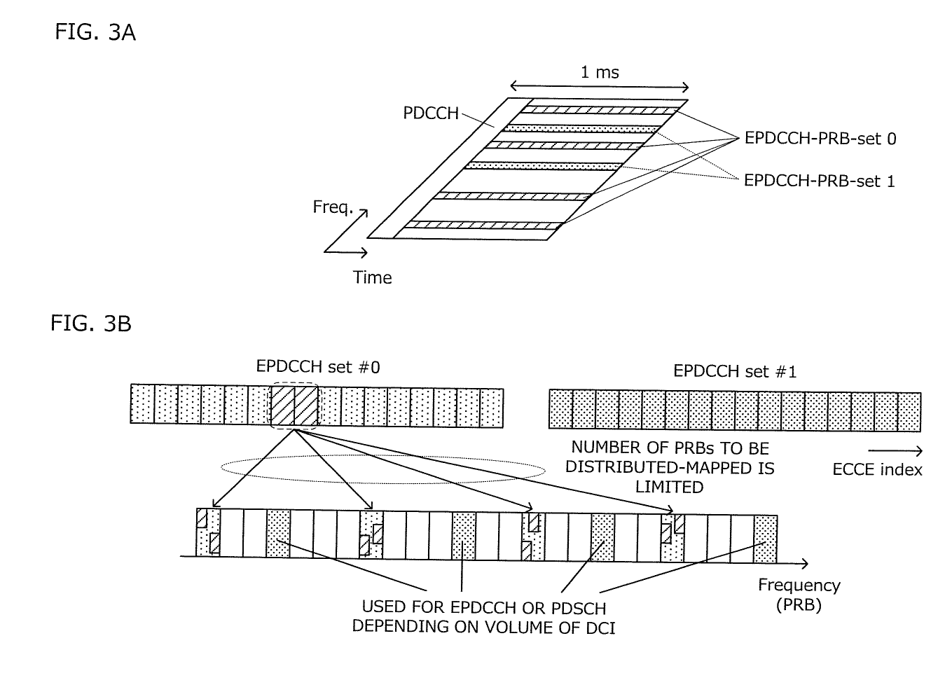

The existing EPDCCH can support up to two EPDCCH sets per user terminal. FIG. 3A is a diagram to show two EPDCCHs sets configured in one subframe. The beginning of the subframe is a PDCCH region, which is frequency-multiplexed with the data region and provides EPDCCH-PRB sets #0 and #1.

The user terminal performs blind decoding on each EPDCCH set. The user terminal can change the number of EPDCCH sets to use according to the number of DCIs to transmit. As shown in FIG. 3B, when the number of DCIs is small, only one EPDCCH set can be used for DCI transmission and the remaining EPDCCH sets can be used to transmit the PDSCH (Physical Downlink Shared Channel). When the number of DCIs is large, up to two EPDCCH sets can be used for DCI transmission.

The parameters of the EPDCCH are configured by higher layer signaling (RRC (Radio Resource Control) signaling). The number of physical resource blocks (PRBs) per EPDCCH set can be independently set for each set, from 2, 4 or 8 PRBs. As a transmission method for each EPDCCH set, distributed transmission can be configured for EPDCCH set #0 and localized transmission can be configured for EPDCCH set #1.

As shown in Table 1, the number of search space candidates can also be divided between the two sets so that the total number of times blind decoding is performed on the two EPDCCH sets will not increase. In the example shown in Table 1, distributed transmission is applied to both sets, and the number of PRBs in each set is four PRBs.

TABLE 1

| | |
|---|---|
| | Number of |
| Aggregation | BD trials |

| level | Set #0 | Set #1 |
|---|---|---|
| 2 | 3 | 3 |
| 4 | 3 | 3 |
| 8 | 1 | 1 |
| 16 | 1 | 1 |
| Total | 8 | 8 |

In cross-carrier scheduling in enhanced carrier aggregation, cross-carrier scheduling is applied to many component carriers, and so existing methods supporting up to two EPDCCH sets may not be able to provide sufficient EPDCCH capacity. If EPDCCH capacity is insufficient, it may be possible to set the maximum number of EPDCCH sets to be greater than two, but no specific way of user terminal control and allocating EPDCCH sets in this case has been provided.

Therefore, the present inventors have found out a method of user terminal control and a method of EPDCCH set allocation in the case where the maximum number of EPDCCH sets is configured to be larger than two so as to support cross-carrier scheduling in enhanced carrier aggregation.

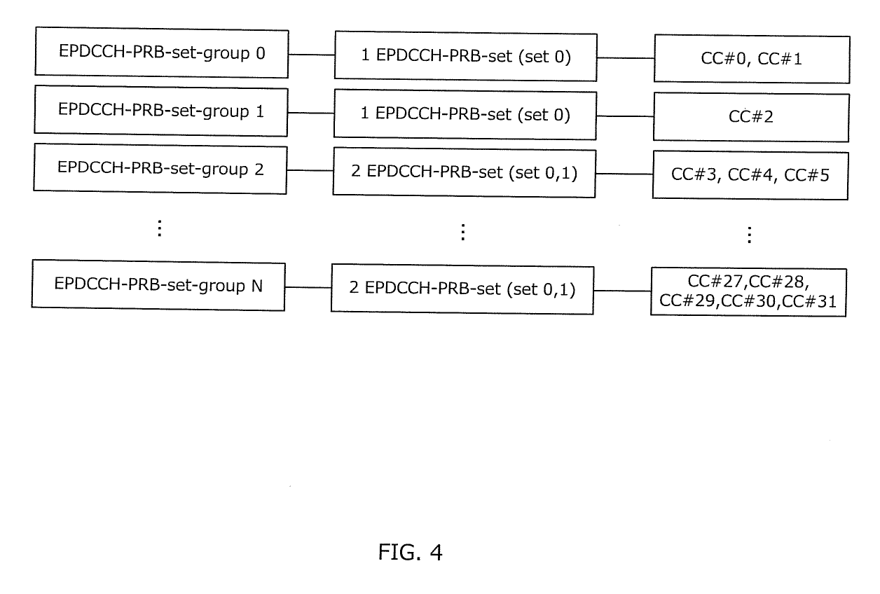

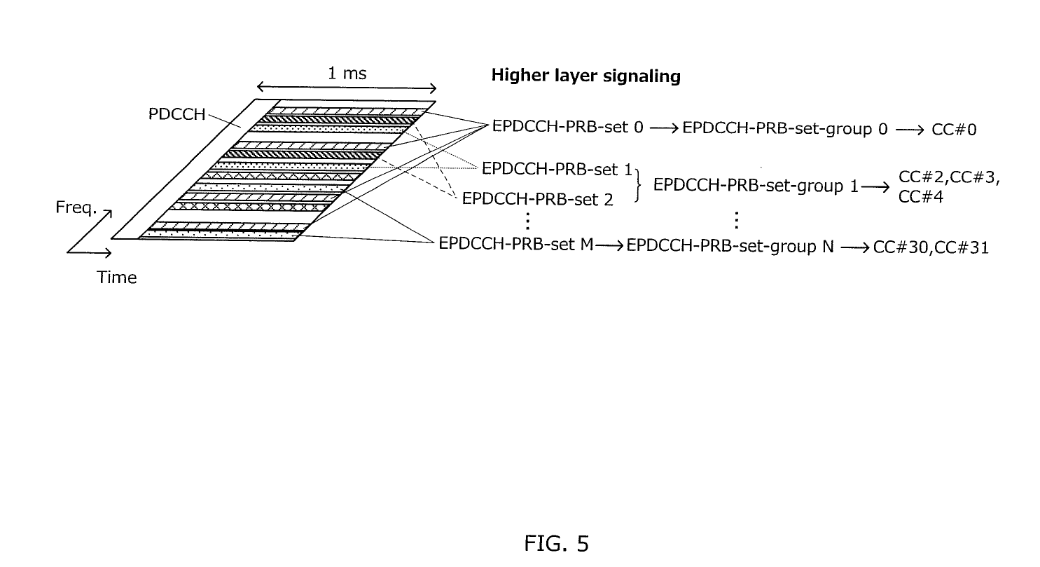

When the maximum number of EPDCCH sets is larger than two, the concept of EPDCCH set groups, which have a grouping role at a higher level above conventional EPDCCH sets (see FIGS. 4 and 5), is introduced. One EPDCCH set group can accommodate the conventional maximum number of EPDCCH sets of two. One or more EPDCCH set groups are configured in the user terminal by high layer signaling (RRC signaling).

In each EPDCCH set group, it is possible to send and receive the DCI of all or some of the component carriers that perform carrier aggregation. The component carriers to transmit scheduling control information in each EPDCCH set group are configured in the user terminal by higher layer signaling. In other words, in each EPDCCH set group, the user terminal blind-decodes only the DCI formats of the component carriers that are configured. That is, according to the present embodiment, in which EPDCCH set group DCI is transmitted is determined per component carrier.

In each EPDCCH set group, the formula for determining the search space for blind decoding is defined as follows.

The starting location of the user terminal-specific search space in the EPDCCH when supporting cross-carrier scheduling is defined in LTE Rel. 11 by following equation 1:

$$L \{ ( {Y}_{p , k} + ⌊ \frac{m \cdot {N}_{ECCE , p , k}}{L \cdot {M}_{p}^{( L )}} ⌋ + b ) mod ⌊ {N}_{ECCE , p , k} / L ⌋ \} + i \qquad ( Equation 1 )$$

where L is the aggregation level, Y_{p,k}=(Aₚ·Y_{p,k-1})modD, Yₚ₋₁=n_{RNTI}≠0, A₀=39827, A₁=39829, D=65537, k=[nₛ/2], nₛ is the slot index in the radio frame, m=0, . . . , Mₚ(L)−1, M^{(L)}ₚ is the number of candidate EPDCCH candidates at aggregation level L in EPDCCH-set p, b=n_{CI}, n_{CI} is the CIF value, N_{ECCE,p,k} is the total number of ECCEs in the control portion in EPDCCH-PRB-set p in subframe k, and i=0, . . . , L−1.

The starting location of the user terminal-specific search space in the EPDCCH in each EPDCCH set group is defined by following equation 2.

$$L \{ ( {Y}_{p , k} + ⌊ \frac{m \cdot {N}_{ECCE , n , p , k}}{L \cdot {M}_{n , p}^{( L )}} ⌋ + b ) mod ⌊ {N}_{ECCE , n , p , k} / L ⌋ \} + i \qquad ( Equation 2 )$$

where L is the aggregation level, Y_{p,k}=(Aₚ·Y_{p,k-1})modD, Yₚ₋₁=n_{RNTI}≠0, A₀=39827, A₁=39829, D=65537, k=[nₛ/2], nₛ is the slot index in the radio frame, m=0, . . . , M_{n,p}^{(L)}−1, M_{n,p}^{(L)} is the number of EPDCCH candidates at aggregation level L in EPDCCH-PRB set p in group n, b=n_{CI}, n_{CI} is the CIF value, N_{ECCE,n,p,k} is the total number of ECCEs in the control portion in EPDCCH-PRB-set p in group n of subframe k, i=0, . . . , L−1, and n is the EPDCCH-PRB-set-group index, n=0, 1, . . . , N.

In the example shown in FIG. 4, EPDCCH set groups #0 to #N are configured in user terminals by higher layer signaling. For example, EPDCCH set group #0 shown in FIG. 4 includes one EPDCCH set (EPDCCH set #0). Further, CC #0 and CC #1 are configured in the user terminal by higher layer signaling as component carriers that transmit scheduling control information in EPDCCH set group #0. The user terminal determines candidates for the user terminal-specific search space in the EPDCCH in EPDCCH set group #0 based on equation 2 above. Then, the user terminal blind-decodes the DCI formats of CC #0 and CC #1.

The blind decoding procedure by the user terminal when EPDCCH set groups are configured will be explained. First, the user terminal determines the mapping relationship between the EPDCCH set groups configured by RRC signaling and the component carrier indices. In each EPDCCH set group, the user terminal determines user terminal-specific search space candidates for each b=N_{CI}, each EPDCCH set, and each aggregation level L, based on equation 2 above. The user terminal repeats blind decoding and cyclic redundancy check for each user terminal-specific search space candidate, and detects DCI addressed to the subject terminal in the component carriers associated with that EPDCCH set group.

The maximum number of component carriers component in one EPDCCH set group may be eight or less. As a result, the CIF bits to be included in DCI can be limited to three bits, and therefore the overhead can be reduced. Conventionally, when cross-carrier scheduling is applied, the indices of the cells to be scheduled are reported using three-bit CIFs, included in each DCI. Consequently, by limiting the CIF bits to three bits, the same blind decoding and demodulation as for the conventional EPDCCH can be performed, so that the terminal circuit can be simplified.

When the maximum number of component carriers to be configured in one EPDCCH set group is eight or less, which scheduling target cell's index each CIF bit value included in DCI indicates may be specified by higher layer signaling. That is, when the user terminal detects DCI included in a predetermined EPDCCH set group, the user terminal receives the PDSCH or transmits the PUSCH (Physical Uplink Shared Channel) in scheduling-target cells based on the CIF values included in the DCI and higher layer signaling information that shows which scheduling-target cell's index each CIF value indicates.

In addition, when the maximum number of component carriers configured in one EPDCCH set group is made eight or less, the CIF bits included in the DCI may be associated with the cell indices of the component carriers configured in each EPDCCH set group, in order, from the smallest CIF bit value. For example, in EPDCCH set group #N of FIG. 4, component carriers with cell indices #27, #28, #29, #30 and #31 are configured. When the user terminal detects DCI in an EPDCCH set group, CIF values (0 to 7) included therein so that the CIF value 0=cell index #27, the CIF value 1=cell index #28, the CIF value 2=cell index #29, the CIF value 3=cell index #30 and the CIF value 4=cell index #31, and, based on these, determines scheduling target cells, and receives the PDSCH and/or transmits the PUSCH. In this case, the overhead of higher layer signaling for associating CIF values and cell indices can be reduced.

In a specific EPDCCH set group (for example, EPDCCH set group #0), only component carriers with indices 0 to 4 may be configured. By this means, EPDCCH set group #0 includes only component carriers that are configured in existing carrier aggregation. Accordingly, even in the case where a component carrier with an index of 5 or more is added, or even when returning to existing carrier aggregation involving five or fewer component carriers by deleting component carriers, EPDCCH set group #0 can be used continuously without changing its configuration. That is, even when RRC reconfiguration is performed on a component carrier with an index of 5 or more, it is possible to continue existing carrier aggregation operation using component carriers an index of 4 or less, and communication can be maintained with certain throughput.

A specific EPDCCH set group in which only component carriers with an index of 4 or less may be a group including a primary cell (PCell), or may be a group including a serving cell to monitor a common search space. Such a serving cell is a primary cell in the case of carrier aggregation, or a primary secondary cell (PSCell) in the case of dual connectivity. In this specific EPDCCH set group, the operation of monitoring the common search space of the PDCCH may be performed.

Further, one or more EPDCCH set groups may be configured in one predetermined cell, or may be configured in different cells. When one or more EPDCCH set groups are configured in different cells, in addition to information on the component carriers configured in the EPDCCH set groups, information on the component carriers in which the EPDCCH set groups are configured is also indicated to the user terminal by higher layer signaling. This makes it possible to distribute and configure the EPDCCH set groups over a plurality of component carriers.

An EPDCCH set group that transmits and receives DCI including PDSCH or PUSCH scheduling information for a primary cell (PCell) may be configured in the PCell, without being specially indicated by higher layer signaling. This can reduce the overhead of signaling for specifying the component carriers for configuring the EPDCCH set group including the PCell.

The PUCCH (Physical Uplink Control Channel) transmission method when EPDCCH set groups are configured may be determined as follows.

When scheduling control information is detected only in an EPDCCH set group including only component carriers with an index of 4 or less (for example, serving cell indices (ServCellIndex) #0 to #4), the PUCCH may be transmitted by applying the PUCCH transmission method stipulated in LTE Rel. 11. For example, when scheduling control information is detected only in CC #0, PUCCH format 1b may be used. When scheduling control information is detected in CCs #1 to #4, PUCCH format 3 may be used.

When scheduling control information is detected in an EPDCCH set group including component carriers other than component carriers with an index of 4 or less (for example, serving cell indices (ServCellIndex) #0 to #4), the PUCCH may be transmitted by applying the PUCCH transmission method stipulated in LTE Rel. 13. For example, a new large capacity PUCCH format that is called PUCCH format 4 and that can multiplex 20 or more bits per subframe may be used.

As a result, even when enhanced carrier aggregation using six or more component carriers is configured, since existing carrier aggregation can be applied by using a specific EPDCCH set groups, depending on the user's quality and conditions, a dynamic fall back to existing carrier aggregation may be possible.

As described above, by introducing EPDCCH set groups in cross-carrier scheduling in enhanced carrier aggregation, it is possible to increase the capacity of DCI that can be accommodated in the EPDCCH of one component carrier. This makes it possible to avoid situations where scheduling control information cannot be transmitted to many component carriers due to insufficient EPDCCH capacity when the number of component carriers in which cross-carrier scheduling is performed increases.

Further, according to the present embodiment, it is possible to increase the number of EPDCCH sets while maintaining existing EPDCCH mechanism. Furthermore, by limiting the number of component carriers per EPDCCH set group to a maximum of eight or less, it is also possible to re-use existing cross-carrier scheduling mechanisms.

(Structure of Radio Communication System)

Now, the structure of the radio communication system according to the present embodiment will be described below. In this radio communication system, a radio communication method using the above-described EPDCCH set groups is applied.

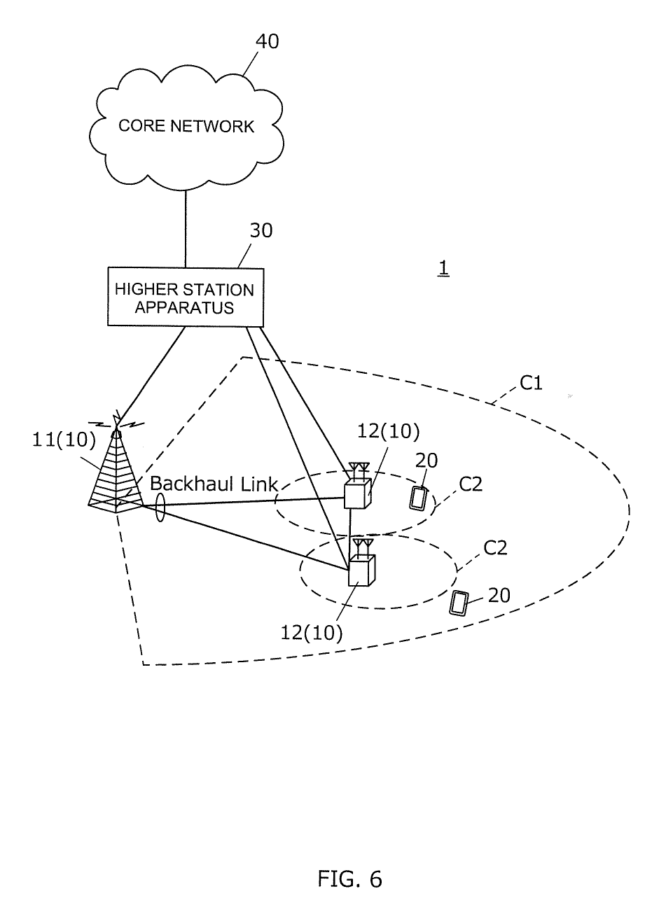

FIG. 6 is a diagram to show an example schematic structure of the radio communication system according to the present embodiment. This radio communication system can adopt one or both of carrier aggregation (CA) and dual connectivity (DC) to group a plurality of fundamental frequency blocks (component carriers) into one, where the LTE system bandwidth constitutes one unit.

As shown in FIG. 6, a radio communication system 1 is comprised of a plurality of radio base stations 10 (11 and 12), and a plurality of user terminals 20 that are present within cells formed by each radio base station 10 and that are configured to be capable of communicating with each radio base station 10. The radio base stations 10 are each connected with a higher station apparatus 30, and are connected to a core network 40 via the higher station apparatus 30.

In FIG. 6, the radio base station 11, for example, for example, a macro base station having a relatively wide coverage, and forms a macro cell C1. The radio base stations 12 are, for example, small base stations having local coverages, and form small cells C2. Note that the number of radio base stations 11 and 12 is not limited to that shown in FIG. 6.

For example, a mode may be possible in which the macro cell C1 is used in a licensed band and the small cells C2 are used in unlicensed bands. Also, a mode may be also possible in which part of the small cells C2 is used in a licensed band and the rest of the small cells C2 are used in unlicensed bands. The radio base stations 11 and 12 are connected with each other via an inter-base station interface (for example, optical fiber, the X2 interface, etc.).

The user terminals 20 can connect with both the radio base station 11 and the radio base stations 12. The user terminals 20 may use the macro cell C1 and the small cells C2, which use different frequencies, at the same time, by way of carrier aggregation or dual connectivity.

The higher station apparatus 30 may be, for example, an access gateway apparatus, a radio network controller (RNC), a mobility management entity (MME) and so on, but is by no means limited to these.

In the radio communication system 1, a downlink shared channel (PDSCH: Physical Downlink Shared CHannel), which is used by each user terminal 20 on a shared basis, a downlink control channel (PDCCH (Physical Downlink Control CHannel), EPDCCH (Enhanced Physical Downlink Control CHannel), etc.), a broadcast channel (PBCH) and so on are used as downlink channels. User data, higher layer control information and predetermined SIBs (System Information Blocks) are communicated in the PDSCH. Downlink control information (DCI) is communicated using the PDCCH and/or the EPDCCH.

Also, in the radio communication system 1, an uplink shared channel (PUSCH: Physical Uplink Shared Channel), which is used by each user terminal 20 on a shared basis, and an uplink control channel (PUCCH: Physical Uplink Control Channel) are used as uplink channels. User data and higher layer control information are communicated by the PUSCH.

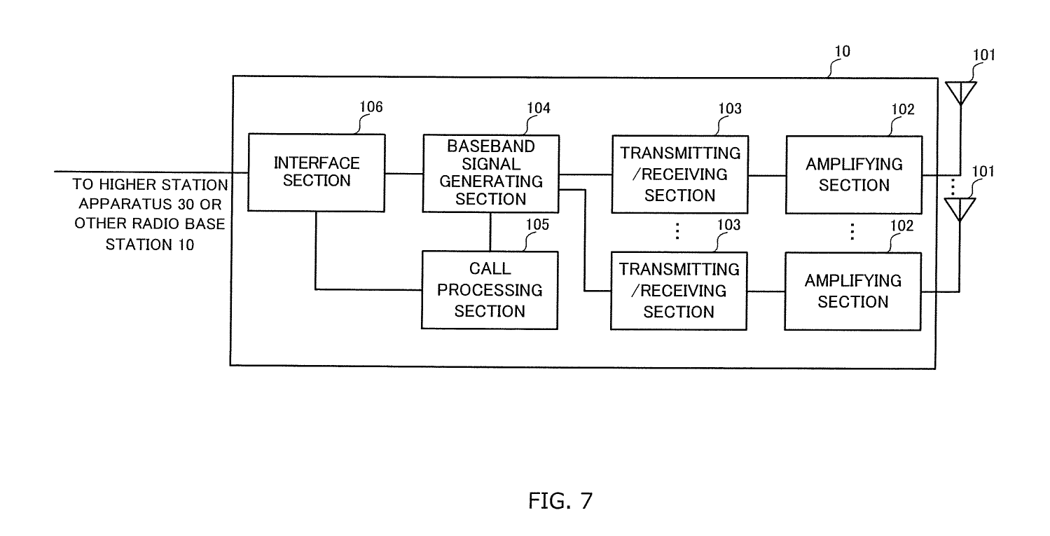

FIG. 7 is a diagram to explain an overall structure of a radio base station 10 according to the present embodiment. As shown in FIG. 7, the radio base station 10 has a plurality of transmitting/receiving antennas 101 for MIMO (Multiple Input Multiple Output) communication, amplifying sections 102, transmitting/receiving sections (transmitting sections and receiving sections) 103, a baseband signal processing section 104, a call processing section 105 and an interface section 106.

User data to be transmitted from the radio base station 10 to a user terminal 20 on the downlink is input from the higher station apparatus 30, into the baseband signal processing section 104, via the interface section 106.

In the baseband signal processing section 104, the user data is subjected to a PDCP (Packet Data Convergence Protocol) layer process, user data division and coupling, RLC (Radio Link Control) layer transmission processes such as an RLC retransmission control transmission process, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts downlink signals that are pre-coded and output from the baseband signal processing section 104 on a per antenna basis, into a radio frequency bandwidth. The radio frequency signals subjected to frequency conversion in the transmitting/receiving sections 103 are amplified in the amplifying sections 102, and transmitted from the transmitting/receiving antennas 101. For the transmitting/receiving sections 103, transmitters/receivers, transmitting/receiving circuits or transmitting/receiving devices that can be described based on common understanding of the technical field to which the present invention pertains can be used.

As for uplink signals, radio frequency signals that are received in the transmitting/receiving antennas 101 are each amplified in the amplifying sections 102, converted into baseband signals through frequency conversion in each transmitting/receiving section 103, and input into the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the interface section 106. The call processing section 105 performs call processing such as setting up and releasing communication channels, manages the state of the radio base station 10 and manages the radio resources.

The interface section 106 transmits and receives signals to and from neighboring radio base stations (backhaul signaling) via an inter-base station interface (for example, optical fiber, the X2 interface, etc.). Alternatively, the interface section 106 transmits and receives signals to and from the higher station apparatus 30 via a predetermined interface.

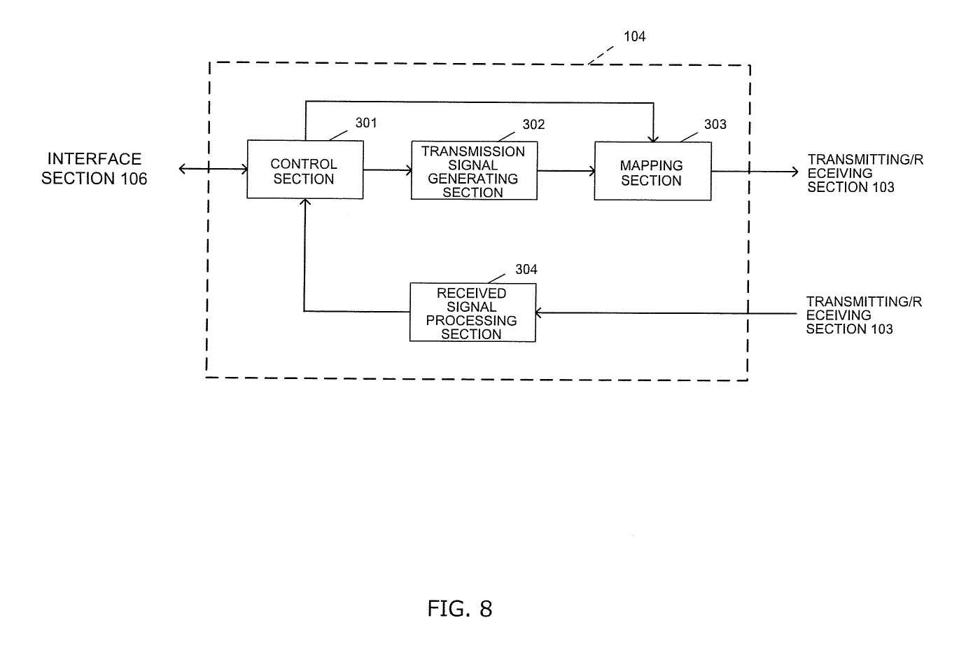

FIG. 8 is a diagram to show a principle functional structure of the baseband signal processing section 104 provided in the radio base station 10 according to the present embodiment. As shown in FIG. 8, the baseband signal processing section 104 provided in the radio base station 10 is comprised at least of a control section 301, a transmission signal generating section 302, a mapping section 303 and a received signal processing section 304.

The control section 301 controls the scheduling of downlink user data that is transmitted in the PDSCH, downlink control information that is communicated in one or both of the PDCCH and the enhanced PDCCH (EPDCCH), downlink reference signals and so on. Also, the control section 301 controls the scheduling (allocation control) of RA preambles communicated in the PRACH, uplink data that is communicated in the PUSCH, uplink control information that is communicated in the PUCCH or the PUSCH, and uplink reference signals. Information about the allocation control of uplink signals (uplink control signals, uplink user data, etc.) is reported to the user terminals 20 by using downlink control signals (DCI).

The control section 301 controls the allocation of radio resources to downlink signals and uplink signals based on command information from the higher station apparatus 30, feedback information from each user terminal 20 and so on. That is, the control section 301 functions as a scheduler. For the control section 301, a controller, a control circuit or a control device that can be described based on common understanding of the technical field to which the present invention pertains can be used.

The control section 301 exerts control such that one or a plurality of EPDCCH set groups and component carrier indices corresponding to each EPDCCH set group are configured in the user terminal 20 by higher layer signaling.

The transmission signal generating section 302 generates downlink signals based on commands from the control section 301 and outputs these signals to the mapping section 303. For example, the downlink control signal generating section 302 generates downlink assignments, which report downlink signal allocation information, and uplink grants, which report uplink signal allocation information, based on commands from the control section 301. Also, the downlink data signals are subjected to a coding process and a modulation process, based on coding rates and modulation schemes that are selected based on channel state information (CSI) from each user terminal 20 and so on. For the transmission signal generating section 302, a signal generator or a signal generating circuit that can be described based on common understanding of the technical field to which the present invention pertains can be used.

The mapping section 303 maps the downlink signals generated in the transmission signal generating section 302 to predetermined radio resources based on commands from the control section 301, and outputs these to the transmitting/receiving sections 103. For the mapping section 303, a mapper, a mapping circuit or a mapping device that can be described based on common understanding of the technical field to which the present invention pertains can be used.

The received signal processing section 304 performs the receiving process (for example, demapping, demodulation, decoding and so on) of the UL signals that are transmitted from the user terminals (for example, delivery acknowledgement signals (HARQ-ACKs), data signals that are transmitted in the PUSCH, random access preambles that are transmitted in the PRACH, and so on). The processing results are output to the control section 301. By using the received signals, the received signal processing section 304 may measure the received power (for example, the RSRP (Reference Signal Received Power)), the received quality (for example, the RSRQ (Reference Signal Received Quality)), channel states and so on. The measurement results may be output to the control section 301. The received signal processing section 304 can be constituted by a signal processor, a signal processing circuit or a signal processing device, and a measurer, a measurement circuit or a measurement device that can be described based on common understanding of the technical field to which the present invention pertains.

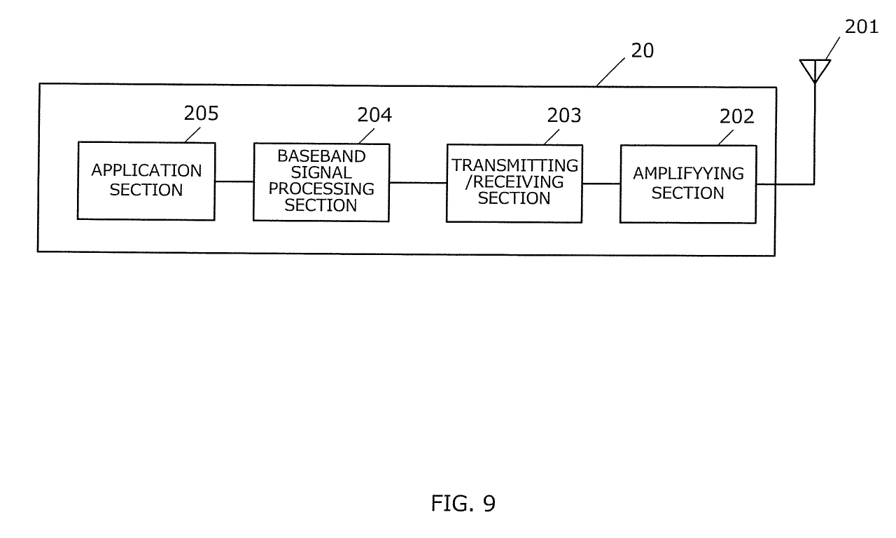

FIG. 9 is a diagram to show an overall structure of a user terminal 20 according to the present embodiment. As shown in FIG. 9, the user terminal 20 has a plurality of transmitting/receiving antennas 201 for MIMO communication, amplifying sections 202, transmitting/receiving section (transmission section and receiving section) 203, a baseband signal processing section 204 and an application section 205.

A radio frequency signal that is received the transmitting/receiving antenna 201 is amplified in the amplifying section 202 and converted into the baseband signal through frequency conversion in the transmitting/receiving section 203. This baseband signal is subjected to an FFT process, error correction decoding, a retransmission control receiving process and so on in the baseband signal processing section 204. In this downlink data, downlink user data is forwarded to the application section 205. The application section 205 performs processes related to higher layers above the physical layer and the MAC layer, and so on. Furthermore, in the downlink data, broadcast information is also forwarded to the application section 205. For the transmitting/receiving section 203, a transmitter/receiver, a transmitting/receiving circuit or a transmitting/receiving device that can be described based on common understanding of the technical field to which the present invention pertains can be used.

Uplink user data is input from the application section 205 to the baseband signal processing section 204. In the baseband signal processing section 204, a retransmission control (HARQ) transmission process, channel coding, precoding, a discrete Fourier transform (DFT) process, an inverse fast Fourier transform (IFFT) process and so on are performed, and the result is forwarded to transmitting/receiving section 203. The baseband signal that is output from the baseband signal processing section 204 is converted into a radio frequency band in the transmitting/receiving section 203. After that, the amplifying section 202 amplifies the radio frequency signal having been subjected to frequency conversion, and transmits the resulting signal from the transmitting/receiving antenna 201.

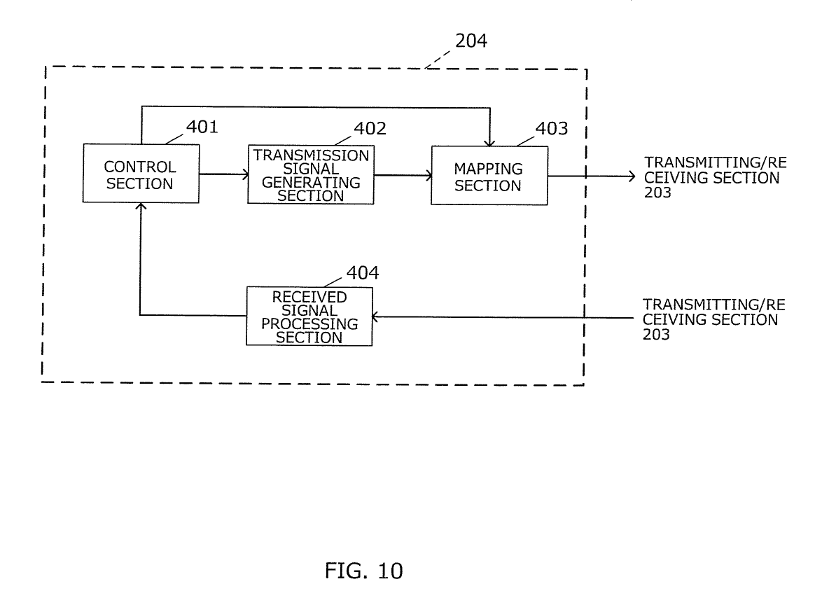

FIG. 10 is a diagram to show a principle functional structure of the baseband signal processing section 204 provided in the user terminal 20. Note that, although FIG. 10 primarily shows functional blocks that pertain to characteristic parts of the present embodiment, the user terminal 20 has other functional blocks that are necessary for radio communication as well. As shown in FIG. 10, the baseband signal processing section 204 provided in the user terminal 20 is comprised at least of a control section 401, a transmission signal generating section 402, a mapping section 403 and a received signal processing section 404.

For example, the control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on. To be more specific, the control section 401 controls the transmission signal generating section 402 and the mapping section 403.

Based on one or a plurality of EPDCCH set groups configured by the radio base station 10 and component carrier indices corresponding to each EPDCCH set group, the control section 401 performs control so that blind decoding is performed on the EPDCCH sets included in the EPDCCH set groups and the DCI of the component carriers corresponding to the EPDCCH set groups is detected.

The transmission signal generating section 402 generates uplink signals based on commands from the control section 401, and outputs these signals to the mapping section 403. For example, the transmission signal generating section 402 generates uplink control signals such as delivery acknowledgement signals (HARQ-ACKs) and channel state information (CSI) based on commands from the control section 401. Also, the transmission signal generating section 402 generates uplink data signals based on commands from the control section 401. For example, when an uplink grant is included in a downlink control signal that is reported from the radio base station 10, the control section 401 commands the transmission signal generating section 402 to generate an uplink data signal. For transmission signal generating section 402, a signal generator or a signal generating circuit that can be described based on common understanding of the technical field to which the present invention pertains can be used.

The mapping section 403 maps the uplink signals generated in the transmission signal generating section 402 to radio resources based on commands from the control section 401, and output the result to the transmitting/receiving sections 203. For the mapping section 403, mapper, a mapping circuit or a mapping device that can be described based on common understanding of the technical field to which the present invention pertains can be used.

The received signal processing section 404 performs the receiving process (for example, demapping, demodulation, decoding and so on) of DL signals (for example, downlink control signals transmitted from the radio base station, downlink data signals transmitted in the PDSCH, and so on). The received signal processing section 404 outputs the information received from the radio base station 10, to the control section 401. The received signal processing section 404 outputs, for example, broadcast information, system information, paging information, RRC signaling, DCI and so on, to the control section 401.

Also, the received signal processing section 404 may measure the received power (RSRP), the received quality (RSRQ) and channel states, by using the received signals. The measurement results may be output to the control section 401.

The received signal processing section 404 can be constituted by a signal processor, a signal processing circuit or a signal processing device, and a measurer, a measurement circuit or a measurement device that can be described based on common understanding of the technical field to which the present invention pertains.

Note that the block diagrams that have been used to describe the above embodiment show blocks in function units. These functional blocks (components) may be implemented in arbitrary combinations of hardware and software. The means for implementing each functional block is not particularly limited. That is, each functional block may be implemented with one physically-integrated device, or may be implemented by connecting two or more physically-separate devices via radio or wire and using these multiple devices.

For example, part or all of the functions of radio base stations 10 and user terminals 20 may be implemented using hardware such as ASICs (Application-Specific Integrated Circuits), PLDs (Programmable Logic Devices), FPGAs (Field Programmable Gate Arrays), and so on. The radio base stations 10 and user terminals 20 may be implemented with a computer device that includes a processor (CPU), a communication interface for connecting with networks, a memory and a computer-readable storage medium that stores programs.

The processor and the memory are connected with a bus for communicating information. The computer-readable recording medium is a storage medium such as, for example, a flexible disk, an opto-magnetic disk, a ROM, an EPROM, a CD-ROM, a RAM, a hard disk and so on. Also, the programs may be transmitted from the network through, for example, electric communication channels. The radio base stations 10 and user terminals 20 may include input devices such as input keys and output devices such as displays.

The functional structures of the radio base stations 10 and user terminals 20 may be implemented by using the above-described hardware, may be implemented by using software modules to be executed on the processor, or may be implemented by combining both of these. The processor controls the whole of the user terminals by running an operating system. The processor reads programs, software modules and data from the storage medium into the memory, and executes various types of processes. These programs have only to be programs that make a computer execute each operation that has been described with the above embodiments. For example, the control section 401 of the user terminals 20 may be stored in a memory and implemented by a control program that operates on the processor, and other functional blocks may be implemented likewise.

Note that the present invention is by no means limited to the above embodiments and can be carried out with various changes. The sizes and shapes illustrated in the accompanying drawings in relationship to the above embodiment are by no means limiting, and may be changed as appropriate within the scope of optimizing the effects of the present invention. Besides, implementations with various appropriate changes may be possible without departing from the scope of the object of the present invention.

The disclosure of Japanese Patent Application No. 2015-080328, filed on Apr. 9, 2015, including the specification, drawings and abstract, is incorporated herein by reference in its entirety.

1. A user terminal that can communicate with a radio base station using six or more component carriers, comprising a control section that exerts control so that, based on one or a plurality of EPDCCH (Enhanced Physical Downlink Control Channel) set groups configured by the radio base station, and a component carrier index corresponding to each EPDCCH set group, blind decoding is performed on an EPDCCH set included in each EPDCCH set group, and DCI (Downlink Control Information) of a component carrier corresponding to each EPDCCH set group is detected.

2. The user terminal according to claim 1, wherein a component carrier index indicates a component carrier that transmits scheduling control information in each EPDCCH set group.

3. The user terminal according to claim 1, wherein each EPDCCH set group includes maximum two EPDCCH sets.

4. The user terminal according to claim 1, wherein the number of component carriers corresponding to each EPDCCH set group is eight or less.

5. The user terminal according to claim 1, wherein only component carriers having a component carrier index of 0 or more and 4 or less are configured in association with a specific EPDCCH set group among the EPDCCH set groups.

6. The user terminal according to claim 5, wherein the specific EPDCCH set group is a group including a primary cell.

7. The user terminal according to claim 5, wherein the specific EPDCCH set group is a group including a serving cell to monitor a common search space.

8. A radio base station that can communicate with a user terminal using six or more component carriers, comprising a control section that exerts control so that one or a plurality of EPDCCH (Enhanced Physical Downlink Control Channel) set groups and a component carrier index corresponding to each EPDCCH set group are configured in the user terminal by higher layer signaling.

9. A radio communication system comprising a radio base station and a user terminal that communicate by using six or more component carriers, wherein:
the radio base station comprises a control section that exerts control so that one or a plurality of EPDCCH (Enhanced Physical Downlink Control Channel) set groups and a component carrier index corresponding to each EPDCCH set group are configured in the user terminal by higher layer signaling; and
the user terminal comprises a control section that exerts control so that, based on the one or the plurality of EPDCCH groups configured by the radio base station and the component carrier index corresponding to each EPDCCH set group, blind decoding is performed on an EPDCCH set included in each EPDCCH set group, and DCI (Downlink Control Information) of a component carrier corresponding to each EPDCCH set group is detected.

10. A radio communication method for a user terminal that can communicate with a radio base station using six or more component carriers, comprising exerting control so that, based on one or a plurality of EPDCCH (Enhanced Physical Downlink Control Channel) set groups configured by the radio base station, and a component carrier index corresponding to each EPDCCH set group, blind decoding is performed on an EPDCCH set included in each EPDCCH set group, and DCI (Downlink Control Information) of a component carriers corresponding to each EPDCCH set group is detected.
